(19) United States
(12) Patent Application Publication
(10) Pub. No.: US 2010/0114774 A1
(43) Pub. Date: May 6, 2010

(54) CHARGEBACK DECISIONING SYSTEM

(75) Inventors: Kim Linaman, Oakdale, MN (US); Jason Clausen, Minneapolis, MN (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: MoneyGram International, Inc., Minneapolis, MN (US)

(21) Appl. No.: 12/264,533

(22) Filed: Nov. 4, 2008

(51) Int. Cl. G06Q 40/00

(52) U.S. Cl. 705/44

(57) ABSTRACT

A chargeback received from a merchant processor, which includes a plurality of data elements related to details of a transaction, is automatically processed. At least one of the plurality of data elements is compared with at least one related data element in each of a plurality of stored chargebacks. Similarities are then identified between the compared data elements of the received chargeback and the stored chargebacks. The received chargeback is then accepted or represented based on the similarities identified.

### TECHNICAL FIELD

The present invention relates to systems and methods for processing financial transactions. More specifically, the present invention relates to systems and methods for processing chargebacks associated with payment card transactions.

### BACKGROUND

Merchants who accept credit cards as a form of payment run the risk of receiving chargebacks from disputed credit card transactions. A chargeback is a reversal of a payment card transaction initiated by the consumer who holds the card or the bank that issued the card used in the purchase. This can happen when a consumer discovers fraudulent or unknown transactions on their card statement or online account view. The risk of a chargeback is especially high in transactions that are processed in “Card Not Present” environments, such as transactions made over the telephone or via the internet

In a chargeback, the bank that issued that credit card investigates disputes, and “charges back” the value of the original transaction directly from the merchant's acquiring bank, which is obligated under card network rules to pay the card issuer. The merchant's acquirer then attempts to recover an equal value of the chargeback plus a processing fee from the merchant's bank account. Chargebacks are typically passed on to the merchant as a matter of acquirer policy unless the merchant can prove the transaction was legitimate, or goods and services have been rendered to a consumer claiming otherwise. Sometimes the consumer dispute is unfounded, and their refund claim gets denied. In these situations, the merchant is still charged processing fees.

In cases of credit card fraud, the merchant loses the goods or services sold, the payment, the fees for processing the payment, any currency conversion commissions, and the chargeback processing fee. Thus, many merchants take steps to avoid chargebacks, such as not accepting suspicious transactions. This may spawn collateral damage, where the merchant additionally loses legitimate sales by incorrectly blocking legitimate transactions. There remains a need for improved systems for enabling merchants to manage chargebacks.

### SUMMARY

The invention is an improved system for analyzing chargeback data and for using the results of the analysis to enhance chargeback processing. One embodiment of the invention is a method for automated processing of a chargeback received from a merchant processor. The chargeback includes a plurality of data elements related to details of a transaction. At least one of the plurality of data elements is compared with at least one related data element in each of a plurality of stored chargebacks. Similarities are then identified between the compared data elements of the received chargeback and the stored chargebacks. The received chargeback is then accepted or represented based on the similarities identified.

In another embodiment, the merchant maintains a database of consumer profiles that each includes identifying information about a consumer. A plurality of data elements in a chargeback received from a merchant processor are recorded, and the received chargeback is then associated with a consumer profile based on the plurality of data elements and the identifying information in the consumer profile. At least one of the plurality of data elements is compared with at least one related data element in each of a plurality of stored chargebacks associated with the consumer profile. Similarities are then identified between the compared data elements of the received chargeback and the stored chargebacks. The received chargeback is accepted or represented based on the similarities identified.

In a system for automatically processing chargebacks, a chargeback database stores chargebacks previously received from a merchant processor. A tracking module records information from a plurality of data elements in a chargeback received from the merchant processor. A processor then compares at least one of the plurality of data elements with at least one related data element in each of a plurality of stored chargebacks. The processor also identifies similarities between the compared data elements of the received chargeback and the stored chargebacks. A decisioning module then accepts or represents the received chargeback based on the similarities identified.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram showing the parties involved in generating a chargeback for a disputed financial transaction.

FIG. 2 is a flow diagram of a procedure for processing and responding to a chargeback received from a merchant processor including automated chargeback decisioning according to the present invention.

FIG. 3 is a block diagram of an embodiment of a system for automatically processing chargebacks received from a merchant processor in accordance with an embodiment of the present invention.

FIG. 4 is a flow diagram of a process for automatically determining whether to accept or represent a chargeback according to an embodiment of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

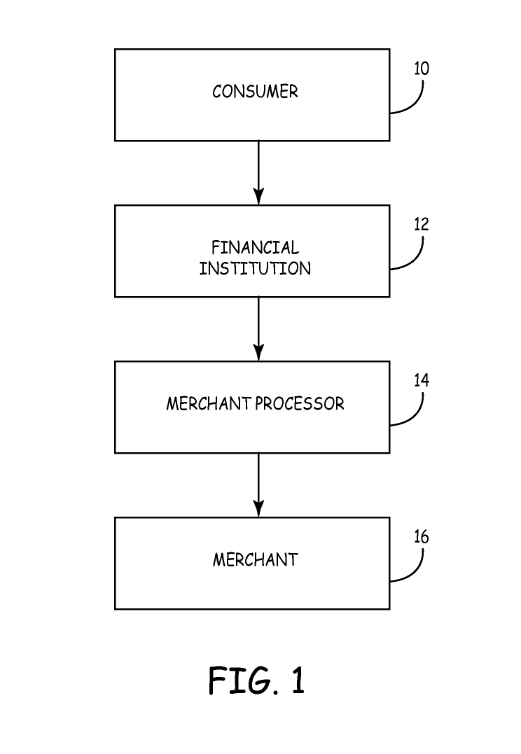

FIG. 1 is a block diagram showing the parties involved in generating a chargeback for a disputed financial transaction. To initiate a chargeback, a consumer 10 may dispute a financial transaction by contacting the financial institution 12 through which the financial transaction was made. For example, the consumer 10 may be a credit card holder and the financial institution 12 may be the bank that issued the credit card. The consumer 10 may initiate the dispute when an allegedly fraudulent or unknown transaction appears on a bill or statement of the consumer 10 for the account associated with the financial transaction. The financial institution 12 may alternatively initiate a dispute of the financial transaction if the financial institution 12 recognizes the financial transaction as suspicious or having known fraudulent characteristics.

After a financial transaction is put in dispute, the consumer 10 is given a temporary credit by the financial institution 12, refunding the amount of the financial transaction to the account of the consumer 10 while the financial transaction is investigated. The financial institution 12 then instructs the merchant processor 14 to charge back the amount of the financial transaction to the merchant 16 in question.

The merchant processor 14 is an organization that processes and settles electronic payment transactions for merchants 16. Merchant processing activities include, among other activities, gathering sales information from the merchant 16, obtaining authorization for the transaction, collecting funds from the financial institution 12, and reimbursing the merchant 16. When the merchant processor 14 receives the dispute from the financial institution 12, the merchant processor 14 forwards the amount of the financial transaction back to financial institution 12 and notifies the merchant 16 of the dispute. The financial institution 12 may then hold this money in escrow while the financial transaction dispute is being processed and analyzed or may provide courtesy credit to consumer.

The merchant processor 14 then prepares a chargeback case for the disputed transaction. For example, the merchant processor 14 may provide a cover page indicating, among other items, the reason for the dispute and the due date for responding to the chargeback. The merchant processor 14 may then provide this cover page to the merchant 16 for viewing and/or printing (e.g., on the website of the merchant processor 14), along with any corresponding support documentation supplied by the financial institution 12. The merchant processor 14 may also mail and/or fax hard copies of the documents to the merchant 16 for research. The merchant processor 14 bills the merchant 16 for the chargeback and for any applicable processing fees.

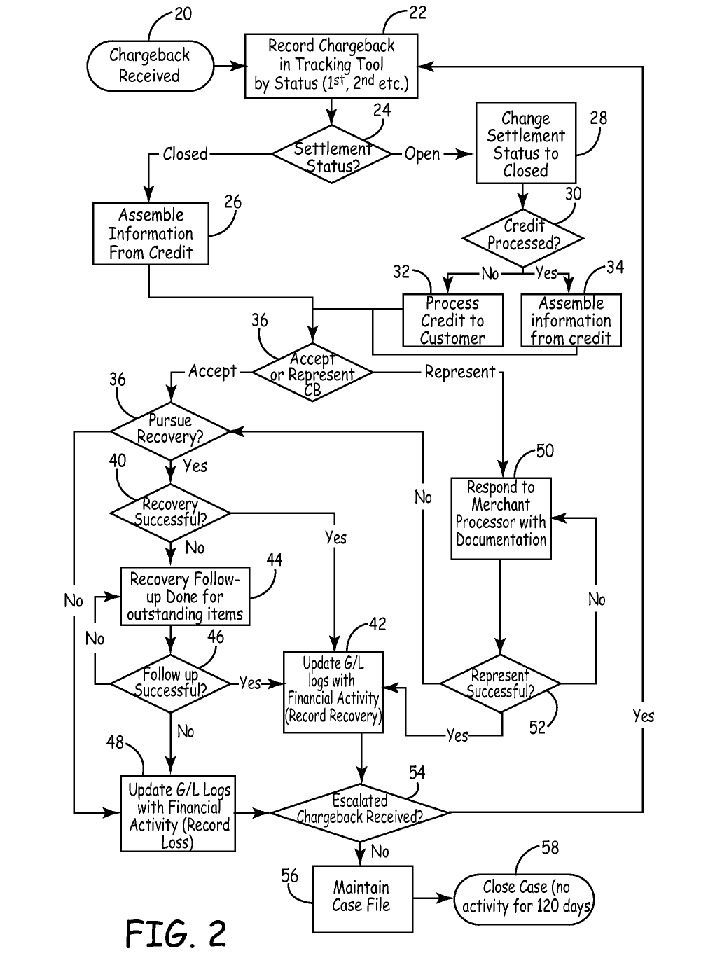

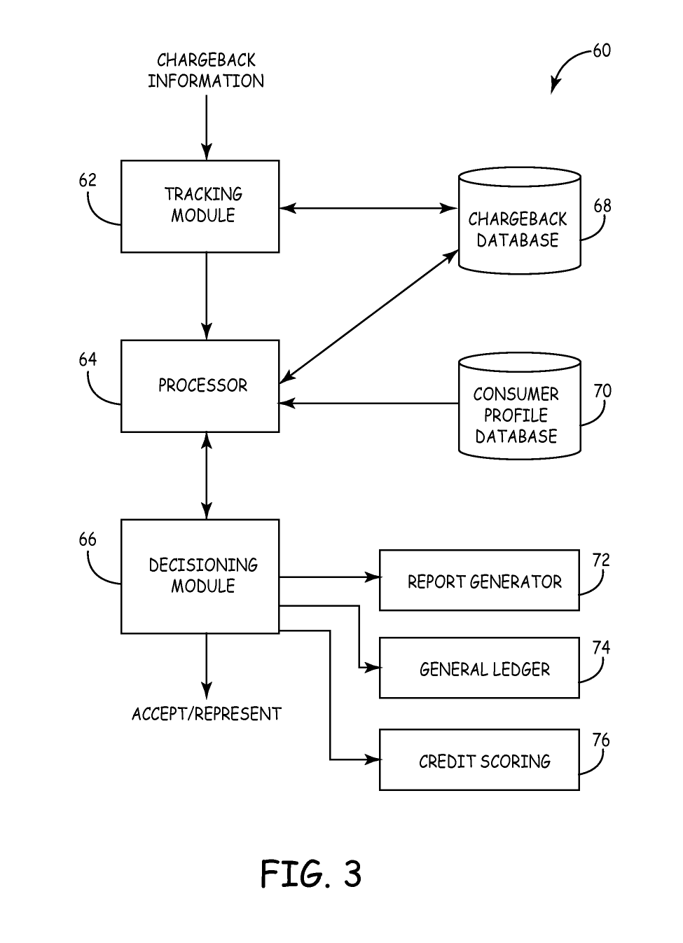

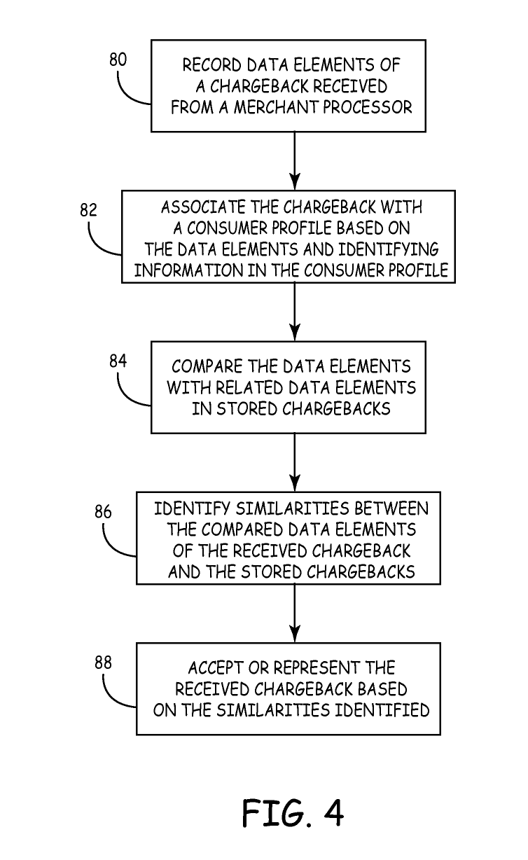

FIG. 2 is a flow diagram of an example procedure including embodiments of the invention for the merchant 16 to process and respond to a chargeback received from the merchant processor 14. In step 20, the merchant 16 receives the chargeback case from the merchant processor 14 and correlates the chargeback with the transaction being disputed. For example, the merchant 16 may associate the chargeback with a transaction in the merchant's general ledger. The merchant 16 then, in step 22, records the chargeback in the merchant's accounting system. The chargeback includes information about the disputed transaction, including identifying information about the consumer 10, information about the transaction (e.g., product purchased in the transaction, location of the transaction, day of the transaction, customer location, etc.), and various other information. The merchant 16 may enter each element of information as a data element in an electronic accounting system for review and analysis. The data elements may be used for automated decisioning of whether to accept or represent the chargeback, as will be described in more detail below with regard to FIGS. 3 and 4.

In decision step 24, the merchant 16 determines whether the chargeback to the financial institution 12 (i.e., the account of consumer 10) requested by the merchant processor 14 has been settled. If the amount of the disputed transaction has been credited back to the financial institution 12, the settlement is closed. Then, in step 26, the merchant 16 assembles all information related to the credit for recording and archiving. For example, the information assembled by the merchant 16 may include any signed forms and transactional data related to the credit.

If, at decision step 24, the status of the chargeback to the financial institution 12 is open, then, in step 28, the status of the settlement is changed to closed. In decision step 30, a determination is made as to whether the amount of the disputed transaction has been credited back to the financial institution 12. If the credit has not been processed in decision step 30, then, in step 32, the amount of the disputed transaction is credited back to the account of the consumer 10 at the financial institution 12. If the credit to the consumer's account has been processed in decision step 30, then, in step 34, the merchant 16 assembles all information related to the credit back to the account of consumer 10 for recording and archiving (similar to step 26 above).

After any of steps 26, 32, or 34, the merchant 16 makes a determination of whether to accept or represent (i.e., dispute) the chargeback in decision step 36. Decision step 36 involves an analysis of the data elements in the chargeback as entered in step 22, as well as an analysis of the data elements compared to corresponding information in a chargeback database. The decision of decision step 36 is generated automatically in accordance with the principles of the present invention. An example system and method for automatically making the decision in decision step 36 will be described in more detail below with regard to FIGS. 3 and 4. When the chargeback is accepted, the merchant 16 agrees not to dispute the chargeback and may pursue other avenues to recover the amount of the chargeback. When the chargeback is represented, the merchant 16 believes that the chargeback is disputable and seeks to have the chargeback reversed.

If the automated decisioning system determines that the chargeback should be accepted in decision step 36, then, in decision step 38, the merchant 16 decides whether to pursue recovery of the amount of the disputed transaction from another source. For example, if the chargeback was accepted in decision step 36 because it was determined that the disputed transaction was fraudulent, the merchant 16 may investigate the fraud to determine the source of the fraudulent transaction. The merchant 16 may then seek recovery of the amount of the chargeback from the party who made the fraudulent transaction using the account of the consumer 10. The merchant 16 may also seek recovery of any other costs and fees associated with the chargeback from the party who made the fraudulent transaction.

If the merchant 16 decides to pursue recovery of the chargeback amount in decision step 38, and, in decision step 40, the recovery is successful, then, in step 42, the merchant 16 updates the general ledger logs with the financial activity of the transaction and records the recovery of the transaction amount. On the other hand, if the merchant 16 decides to pursue recovery of the chargeback amount in decision step 38, but, in decision step 40, the recovery is not successful, the merchant 16 may follow up, in step 44, with additional investigation into any avenues not pursued in the original recovery attempt in decision step 38. If, in decision step 46, the follow up in step 44 is not successful, the merchant 16 may choose to continue to follow up with even further investigation into the transaction in step 44. Alternatively, if, in decision step 46, the merchant 16 decides that all avenues have been exhausted to recover the amount of the chargeback, then, in step 48, the merchant 16 updates the general ledger with the financial activity of the transaction and records the transaction as a loss. Similarly, if the merchant 16 decides in decision step 38 not to pursue recovery of the amount of the chargeback, the transaction amount is recorded in the general ledger as a loss in step 48.

If the automated decisioning system decides to represent the chargeback in decision step 36, then, in step 50, the merchant 16 responds to the merchant processor 14 with documentation that evidences the original dispute leading to the chargeback. For example, the merchant 16 may provide documentation that the goods were received and accepted by the consumer 10, or the merchant 16 may demonstrate that the particular consumer 10 has a history of disputing transactions. The merchant processor 14 then passes the documentation on to the financial institution 12 for review. If, in decision step 52, the financial institution 12 determines that the chargeback is acceptable (i.e., the representation is not successful), the merchant 16 may then respond with additional documentation to dispute the transaction or opt to pursue recovery of the amount of the disputed transaction from another source starting at decision step 38. On the other hand, if, in decision step 52, the representation of the chargeback is successful, then, in step 42, the merchant 16 may update the general ledger logs with the financial activity of the transaction and record the recovery.

When the general ledger is updated with either a recovery in step 42 or a loss in step 48, then, in decision step 54, the merchant 16 reviews any unprocessed chargebacks to determine whether an escalated chargeback has been received from the merchant processor 14. An escalated chargeback may be a duplicate chargeback arising from a representation of the original transaction or a new chargeback having characteristics similar to the chargeback received in step 20, for example. The determination of the presence of escalated chargebacks may be done electronically by comparing information in the decisioned chargeback with chargebacks awaiting processing. If an escalated chargeback is received, the process returns to step 22, and the merchant 16 records details about the escalated chargeback in the merchant's system and subsequently processes the escalated chargeback. The escalated chargeback may provide further evidence that the original chargeback was fraudulent, or that a pattern of improper chargebacks is being received from the consumer 10. If no escalated chargeback is received in decision step 54, then, in step 56, a file for the chargeback received in step 20 is maintained by the merchant 16. After a period of inactivity with the disputed transaction, the chargeback case is closed in step 58.

FIG. 3 is a block diagram of a system 60 suitable for automatically deciding whether to accept or represent a chargeback, for example to generate an output for decision step 36. System 60 includes a tracking module 62, a processor 64, a decisioning module 66, a chargeback database 68, a customer profile database 70. Also shown in system 60 are a report generator 72, a general ledger 74, and a credit scoring system 76 each of which may or may not be located locally with the remaining components of system 60. The tracking module 62 receives information about a chargeback as an input and communicates with the processor 64 and the chargeback database 68. The processor 64 receives inputs from the tracking module 62, the chargeback database 68, the customer profile database 70, and provides an output to the decisioning module 66. The decisioning module 66 generates an output as to whether accept or represent the chargeback. The decisioning module 66 also provides outputs to the report generator 72, the general ledger 74, and the credit scoring system 76. A more extensive description of the elements of system 60 is provided below. The chargeback database 68 and the customer profile database 70 may be stored in separate computer readable media or combined in a single computer readable medium. In addition, some or all of the elements of system 60 may be implemented as separate subsystems or combined in a single system. For example, some or all of the elements of system 60 may be components in a data processing system.

FIG. 4 is a flow diagram of a method employable by system 60 for automatically determining whether to accept or represent a chargeback, according to embodiments of the present invention. In step 80, when the chargeback is received from the merchant processor 14, data elements in the chargeback is recorded in the tracking module 62 of system 60. The tracking module 62 may be a software module including an interface for a user to enter the data elements from the chargeback into the system 60. For example, the user may enter information from the chargeback into the tracking module 62 using an input device, such as a keyboard. Alternatively, the tracking module 62 may be configured to extract data elements from the chargeback directly.

The data elements included in the chargeback relate to various aspects of the disputed transaction. The information in the data elements may relate to identifying and transaction information retrieved when the payment card associated with the disputed transaction is swiped in a “card present” transaction, or from account and identifying information entered by the consumer 10 in a “card not present” transaction. For example, in a money transfer system, the chargeback data elements that are entered into tracking module 62 may include some or all of the identifying information about the consumer listed in the Table 1. This information may alternatively or additionally be collected from an electronic transaction request.

TABLE 1
Consumer Data

Consumer's name
Consumer's email address
Domain associated with the email address
Consumer's primary phone number
Consumer's secondary phone number
Consumer's date of birth
Consumer's age
Consumer's address state
Authentication method

The chargeback data elements may also include information about the transaction in dispute. The transaction data elements may be assembled from information from the financial institution 12 and/or the merchant 16. For example, in a money transfer system, the transaction data elements may include some or all of the elements listed in Table

TABLE 2
Transaction Data

Merchant transaction identification
Merchant reference number
Transaction product type
Transaction date and time
Transaction dollar amount
Primary funding source
BIN number of payment card used to fund transaction
Transaction Address Verification System (AVS) result
Transaction destination (country) - if product is sent
Transaction destination (city/state)
Receiver's name
Transaction receive date and time
Receive agent identification
Receive agent location

The chargeback may further include investigation data that is extractable from the consumer and transaction data in the chargeback. The investigation data may also be obtained or assembled while investigating the propriety of the chargeback, and later entered into the tracking module 62. The investigation data may be used not only to determine whether the to accept or represent the chargeback, but also to generate documents and other evidence for use in responding to the merchant processor 14 when the chargeback is represented, or in pursuing recovery when the chargeback is accepted. For example, in a money transfer system, the investigation data may include some or all of the elements listed in Table 3.

TABLE 3
Investigation Data

Was ACH return received?
Was the transaction pended?
Was fraud detected before the chargeback?
Was the chargeback preventable?
Reason for the chargeback (e.g., purchase)?
Is the chargeback considered fraudulent?
Does the profile belong to the cardholder?
Send/receive distance
Does the email address match the sender?
Was the consumer contacted?
Did the consumer contact the merchant?
Are other consumer profiles linked to the consumer?
What is the reason for sending/purchasing?
Were phone numbers verified?
Time associated with receive?

When the data elements in the chargeback have been entered into the tracking module 62, the processor 64 then, in step 82, associates the chargeback with a consumer profile stored in consumer profile database 70. Each consumer profile stored in the consumer profile database 70 includes information such as, for example, identifying information for a consumer 10, account information for the consumer 10, transaction history of the consumer 10 with the merchant 16, typical purchasing characteristics (e.g., typical purchase location) of the consumer 10, and history of chargebacks of the consumer 10 with the merchant 16. The consumer profile may also include information provided by the consumer 10 prior to making the disputed transaction. For example, in internet based transactions, the merchant 16 may have the consumer 10 set up a user profile in order to make a purchase, which may include, among other elements, the consumer's name, address, and credit card information. The information entered by the consumer 10 for the user profile may be used as the basis for the consumer's profile stored in the consumer profile database 70.

In some embodiments, the processor 64 associates the chargeback with a customer profile by matching the data elements entered in the tracking tool 62 with identifying information in a consumer profile. For example, the chargeback may include the name and account number for the consumer 10. The processor 64 may then search the customer profile database 70 to find a consumer profile matching the name and account number in the chargeback. When the chargeback is associated with the consumer profile, the information in the chargeback and customer profile may be reconciled such that data elements missing from the chargeback may be supplied by information in the customer profile.

In step 84, the processor 64 compares the data elements of the chargeback with related data elements in chargebacks stored in the chargeback database 68. The chargeback database 68 stores all chargebacks previously received by the merchant 16. The chargebacks may be catalogued and searchable by data element to facilitate searching of the chargeback database 68. The processor 64 may limit the comparison to data elements that are more likely to give an indication as to whether the received chargeback should be accepted or rejected. In addition, the processor 64 may compare the data elements of the received chargeback with related data elements in stored chargebacks associated with the consumer 10.

In step 86, the processor 64 then identifies similarities between the compared data elements of the received chargeback and the stored chargebacks. In some embodiments, the processor 64 identifies a pattern of similarities among the data elements of the received and stored chargebacks. The processor 64 may optionally generate a chargeback profile based on the pattern of similarities and store this chargeback profile in the chargeback database 68. This chargeback profile may be employed not only to analyze chargebacks as they arrive from the merchant processor 14, but also to prevent transactions likely to result in a chargeback from occurring. For example, the processor 64 may recognize that chargebacks are occurring frequently to elderly consumers in a certain zip code when the address verification system (AVS) does not match, or as a result of pay at the pump transactions during a specific time period. A chargeback profile including these data elements may be created, and when subsequent chargebacks are received having these characteristics, a decision can quickly be made for responding to the chargeback.

In step 88, the decisioning module 66 accepts or represents the received chargeback based on the similarities identified in step 86. The decisioning module 66 is a software algorithm that is configured to analyze the information from the processor 64. For example, the decisioning module 66 may determine that the chargeback has data elements similar to previously represented chargebacks, and decide that the chargeback should be represented. As another example, the decisioning module 66 may determine that the chargeback has characteristics of known accepted chargebacks and decide that the chargeback should be accepted. The decisioning module 66 may also review the chargeback in light of chargeback profiles generated by the processor 64 to expedite the review of the chargeback. When the decisioning module 66 determines whether to accept or represent the chargeback, the process of FIG. 2 proceeds as appropriate from the decision step 36.

After deciding to accept or represent the chargeback, the chargeback may be stored in chargeback database 68. In addition, the information generated by the decisioning module 66 may be provided to other components and systems for subsequent analysis and use. Reports may be generated that allow the user to measure the success of the decisioning module. This enables the user to utilize different parameters in the decisioning module in order to generate better results. For example, the report generator 72 may use the information from the decisioning module 66 to identify potential sources of additional chargebacks and generate a report for future chargeback identification and prevention. The decisioning module 66 may also provide the decision to the general ledger 74 of the merchant 16 for recording the outcome of the transaction.

The decisioning module 66 may also provide the information used to determine whether to accept or reject a transaction in a credit scoring system 76. In one embodiment, the credit scoring system 76 may use chargeback information to recognize potentially fraudulent or suspicious transactions at the point of sale. The decisioning module may be integrated into a credit scoring system enabling it to analyze chargeback history as a factor in allowing or declining a transaction. The transaction may be prevented from occurring, thereby preventing a transaction likely to result in a chargeback from occurring in the first place.

In summary, the present invention relates to automatically processing a chargeback received from a merchant processor. The chargeback includes a plurality of data elements related to details of a transaction. At least one of the plurality of data elements is compared with at least one related data element in each of a plurality of stored chargebacks. Similarities are then identified between the compared data elements of the received chargeback and the stored chargebacks. The received chargeback is then accepted or represented based on the parameters established in the decisioning module. The chargeback decisioning system as described is customizable by the merchant to fit the needs of the merchant's business. For example, the merchant may modify the data elements reviewed by the system for a particular consumer or for particular transaction parameters. The system is applicable to card present and card not present transactions, and may also be integrated with existing scoring models to identify and reject high risk transactions at the front end to avoid chargebacks. The ability to predict and decision chargebacks in an automated manner reduces labor costs, increases productivity, improves fraud prevention, reduces losses for the merchant, and improves brand protection for the merchant.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

What is claimed is:

1. A method for automated processing of a chargeback received from a merchant processor, wherein the chargeback includes a plurality of data elements related to details of a transaction, the method comprising:
comparing at least one of the plurality of data elements with at least one related data element in each of a plurality of stored chargebacks;
identifying similarities between the compared data elements of the received chargeback and the stored chargebacks; and
accepting or representing the received chargeback based on the similarities identified.

2. The method of claim 1, and further comprising:
storing the received chargeback with the stored chargebacks.

3. The method of claim 1, and further comprising:
identifying a pattern of similarities between data elements of the received chargeback and data elements of the stored chargebacks.

4. The method of claim 3, and further comprising:
generating a chargeback profile based on the identified pattern of similarities.

5. The method of claim 4, and further comprising:
identifying high risk financial transactions based at least in part on the chargeback profile.

6. The method of claim 1, and further comprising:
updating electronic records associated with the transaction if the chargeback is accepted.

7. The method of claim 1, wherein the at least one of the plurality of data elements to be compared is selectable from a list of data elements.

8. The method of claim 1, wherein the plurality of data elements comprises at least one of consumer identification information and transaction information.

9. A method for automatically processing chargebacks for a merchant, wherein the merchant maintains a database of consumer profiles, and wherein each consumer profile includes identifying information about a consumer, the method comprising
recording a plurality of data elements on a chargeback received from a merchant processor;
associating the chargeback with a consumer profile based on the plurality of data elements and the identifying information in the consumer profile;
comparing at least one of the plurality of data elements with at least one related data element in each of a plurality of stored chargebacks associated with the consumer profile;
identifying similarities between the compared data elements of the received chargeback and the stored chargebacks; and
accepting or representing the received chargeback based on the similarities identified.

10. The method of claim 9, and further comprising:
storing the received chargeback with the stored chargebacks.

11. The method of claim 9, and further comprising:
identifying a pattern of similarities among the data elements of the received chargeback and the stored chargebacks.

12. The method of claim 11, and further comprising:
generating a chargeback profile for the consumer based on the identified pattern of similarities.

13. The method of claim 12, and further comprising:
identifying high risk financial transactions associated with the consumer based at least in part on the chargeback profile.

14. The method of claim 9, wherein the at least one of the plurality of data elements to be compared is selectable from a list of data elements.

15. The method of claim 9, wherein the plurality of data elements comprises at least one of consumer identification information and transaction information.

16. A system for automatically processing chargebacks, the system comprising:
a chargeback database operable to store chargebacks previously received from a merchant processor;
a tracking module for recording information from a plurality of data elements in a chargeback received from the merchant processor, wherein the plurality of data elements relates to details of a transaction;
a processor operable to compare at least one of the plurality of data elements with at least one related data element in each of a plurality of stored chargebacks, and to identify similarities between the compared data elements of the received chargeback and the stored chargebacks; and
a decisioning module operable to accept or represent the received chargeback based on the similarities identified.

17. The system of claim 16, wherein the processor is further operable to identify a pattern of similarities among the data elements of the received chargeback and the stored chargebacks.

18. The system of claim 17, wherein the processor is further operable to generate a chargeback profile based on the identified pattern of similarities.

19. The system of claim 18, wherein the processor is further operable to identify high risk financial transactions associated with the consumer based at least in part on the chargeback profile.

20. The system of claim 16, and further comprising:
a consumer profile database operable to store consumer profiles, wherein each consumer profile includes identifying information about a consumer.

21. The system of claim 20, wherein the processor is further operable to associating the chargeback received from the merchant processor with a consumer profile based on the plurality of data elements in the received chargeback and the identifying information in the consumer profile.
